(19) United States
(12) Patent Application Publication
(10) Pub. No.: US 2008/0193691 A1
(43) Pub. Date: Aug. 14, 2008

(54) Mxd. 10 Polyamide-Based Barrier Structures

(75) Inventors: Philippe Bussi, Versailles (FR); Annett Linemann, Nassandres (FR); Benoit Brulle, Bernay (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 11/911,215

(22) PCT Filed: Apr. 12, 2006
(86) PCT No.: PCT/EP06/04317

§ 371 Date: Oct. 11, 2007

Related U.S. Application Data
(60) Provisional application No. 60/719,838, filed on Sep. 23, 2005.

(30) Foreign Application Priority Data
Apr. 14, 2005 (FR) 05.03712

(51) Int. Cl. C08L 77/06; F16L 9/12; F16L 11/04; B65D 85/84

(52) U.S. Cl. 428/36.9; 525/432; 428/36.92; 524/538

(57) ABSTRACT

The present invention relates to a structure made of at least one layer containing a polyamide MXD.10/Z in which: MXD. 10 is the product of condensation of a blend of xylylenediamines containing 70 to 100% of meta-xylylenediamine and of sebacic acid, Z is a repeating unit chosen at least among the repeating units resulting from the polycondensation of a lactam monomer, from an alpha-omega carboxylic aminoacid, the repeating unit X1. Y1 where X1 designates the repeating unit resulting from the polycondensation an aliphatic, arylaliphatic, cycloapiphatic, or aromatic diamine and Yl designates the repeating unit resulting from the polycondensation of a aliphatic carboxylic, cycloaliphatic or aromatic diacid, and the weight ratio Z/(MXD+10+Z) is between 0 and 15%. The structure of the invention can either be made of one layer of this polyamide or either can contain a layer containing the polyamide MXD.10 and at least one layer of another material. The invention also relates to bottles, tanks, containers, pipes, tubes and many types of containment devices made using the previous structure. This structure can also be used into films to produce goods packaging. All these objects have good barrier properties. The invention also relates to these objects as well as the use of these structures and objects.

### FIELD OF THE INVENTION

The present invention relates to a barrier structure based on polyamide MXD.10. “MXD.10” stands for the product of the condensation of a blend of xylylenediamines containing by weight from 70 to 100% of meta-xylylenediamine and of sebacic acid. This structure can either be made of one layer containing this polyamide or be made of a layer of polyamide MXD.10 and at least one layer of another material. This structure is useful to make bottles, tanks, pipes, tubes and many types of containment devices. This structure can also be made as films with which one can produce, for example, for packaging goods. All these objects show good barrier properties. The invention also relates to the use of these structures and objects.

### THE PRIOR ART AND THE TECHNICAL PROBLEM

The semi-aromatic polyamides such as the polyphtalamides and the MXD.6 generally have elongation at break <50% and are relatively rigid. To improve their mechanic properties it is necessary to blend them with other products.

Patent GB 1490453 discloses blends (i) of a product of condensation of the meta-xylylenediamine with a diacid having from 6 to 12 carbon atoms with (ii) some PA 6.6. The examples disclose some blends of MXD.6 (product of the condensation of the meta-xylylenediamine and the adipic acid) and of PA6.6 (polyhexamethylene adipamide). There is no mention about any barrier properties.

Patent GB 1472615 discloses blends (i) of a product of condensation of the meta-xylylenediame with a diacid having from 6 to 12 carbon atoms with (ii) some fibers. All the examples contain some adipic acid. Like the previous patent, there is no mention about any barrier properties.

Patent EP 940444 discloses blends (i) of a product of condensation of the meta-xylylenediamine with a diacid containing more than 70% of adipic acid with (ii) a product chosen from the metallic salts of fatty acids, the diamides and the diesters. This composition is described as being only slightly affected to whitening when stored in a humid environment. There is no mention about any barrier properties.

Patent application US 2002-0142179 discloses blends (i) of a product of the condensation of the meta-xylylenediamine with a diacid having from 6 to 12 carbon atoms with (ii) a maleic anhydride grafted copolymer of ethylene and ethyl acrylate. All the examples contain MXD.6. A film of this composition is presented as being an oxygen barrier.

Patent EP 1308478 discloses blends (i) of a product of condensation of the meta-xylylenediamine with a diacid made of more than 70% of adipic acid with (ii) a smectite. A film of this composition is presented as being an oxygen barrier.

Patent EP 1350806 discloses blends (i) of a product of condensation of the meta-xylylenediamine with a diacid containing more than 70% of a diacid having from 4 to 20 atoms of carbon with (ii) a smectite. Every example is based on MXD.6. A film of this composition is presented as being an oxygen barrier.

Patent application US 2004-0076781 describes a product of condensation of the meta-xylylenediamine with a blend (i) of a diacid having 4 to 20 atoms of carbon and (ii) of isophtalic acid. Every example is based on MXD.6/MXD.I. A film of this composition is presented as being an oxygen barrier.

We have discovered that the polyamide MXD.10 had simultaneously good barrier properties in addition to good mechanical properties. Among the barrier properties, notes may be made of the barrier properties to water vapor, oxygen and aromas. The prior art (see below) already described the MXD.10 without mentioning the barrier properties. Adding to that, these prior arts did not describe nor suggested a structure either made of one layer of this polyamide or containing a layer of polyamide MXD.10 and at least one layer of another material.

Patent U.S. Pat. No. 2,766,221 discloses the product of condensation of the meta-xylylenediamine with a diacid having from 6 to 10 carbon atoms. Example 3 discloses the preparation of polyamide MXD 10 to produce fibers. It is also mentioned that it can be used to prepare transparent films. There is no mention about any barrier properties.

Patent U.S. Pat. No. 2,878,235 is similar to the previous one. It is disclosed that the elongation at break of the MXD.10 is 360%. There is no mention about any barrier properties.

### BRIEF DESCRIPTION OF THE INVENTION

The present invention relates to a structure containing at least one layer made of polyamide MXD.10/Z in which:
MXD.10 is the product of condensation of a blend of xylylenediamines containing 70 to 100% of meta-xylylenediamine and of sebacic acid,
Z is a repeating unit chosen at least among the repeating units resulting from the polycondensation of a lactam monomer, from an alpha-omega carboxylic aminoacid, the repeating unit X1.Y1 where X1 designates the repeating unit resulting from the polycondensation an aliphatic, arylaliphatic, cycloaliphatic, or aromatic diamine and Y1 designates the repeating unit resulting from the polycondensation of a aliphatic carboxylic, cycloaliphatic or aromatic diacid,

The weight ratio Z/(MXD+10+Z) is between 0 and 15%.

The structure described in this invention can either be made of only one layer of this polyamide, or can contain a layer containing the polyamide MXD.10 and at least one layer of another material. The other material can be for instance any other polyamide (eg PA 6, PA 6.6) or copolyamide, EVOH, a polyolefin (eg polyethylene, polypropylene), a polyester. The polyamide layer of the invention may optionally be either oriented in one direction or stretched biaxially.

In the structure of the invention the layer containing the polyamide MXD.10/Z can also contain other polymers, fillers such as fibers or nanocomposites. This means that the layer containing the polyamide MXD.10/Z is made of a blend of MXD.10/Z and other polymers and optionally fillers. As an example of these other polymers mention may be made of the polyamides, the EVOH, the PPS, the PPO, the polycarbonate, the ABS, toughening agents (EPR), the polyolefins.

These blends of MXD.10/Z with other polymers, fillers such as fibers or nanocomposites are new products by themselves. The invention also relates to these products.

The invention also relates to bottles, tanks, containers, tubes, pipes and many types of containment devices made with the previous structure. This structure can also be a film used to make packaging items. All these objects have good barrier properties. The invention also relates to these objects as well as the use of these structures and objects.

### DETAILED DESCRIPTION OF THE INVENTION

Advantageously the proportion of Z is chosen between 0 and 10% in weight (including the limits) and preferably between 0 and 5%. The lactam-based monomer can be chosen from caprolactam and lauryllactam monomers. The alpha omega carboxylic aminoacid can be aminoundecanoic acid. The number of carbon atoms of X1 can be between 6 and 22. The number of carbon atoms of Y1 can be between 6 and 14. Z can be MXD.Y1, for example MXD 6. This means that the polyamide of the invention can be MXD.10/MXD.6.

The polyamide MXD.10/Z is produced according to the techniques well known for the production of polyamides, like by polycondensation.

In the structure of the invention the layer containing the polyamide MXD.10/Z can also contain other polymers, some fillers such as fibers or nanocomposites but also the usual additives such as the antioxidants, the UV stabilizers, the flame retardants, the antistatic agent such as carbon black, carbon nanotubes and the conductive fibers.

The semi aromatic polyamides used in the structure of the invention show thermo mechanical properties that are within the typical values expected for typical aliphatic polyamides. The melting points (inferior or equal to 190° C.) and the moduli (inferior or equal to 1800 MPa for flexural modulus, inferior or equal to 1500 MPa for the tensile modulus) allow:
the use of the industrial equipments dedicated to the aliphatic polyamides,
an easy processing at a temperature of around 210° C., which makes possible the compounding and co-processing with numerous other polymers (polyamides -PA-, PE, functionalized polyolefins, EVOH) and
an injection/molding using usual molds (not heated).

Their elongation at break being superior or equal to 200% is excellent compared to the classic semi-aromatic PA.

In addition to these thermo mechanical properties, the MXD.10/Z show good barrier properties to oxygen, to water vapor and to gasoline. The density of MXD.10 is lower than the one of MXD.6.

The combination of the thermomechanical properties and the barrier properties make these products useful in several applications, such as:
extruded products: used by itself or compounded in one layer or multi-layer with other materials in the transportation applications (transfer lines for liquids and fuel tanks), of air conditioning (hoses), etc., where good gasoline barrier characteristics are needed.
packaging items: used by itself or compounded in one layer or multi-layer with other materials into films and injected parts for packaging (where oxygen barrier is needed).

### EXAMPLES

### Example 1

### Synthesis of MXD.10

The following monomers are introduced into a reactor equipped with an agitator: 14.1 kg (103.5 moles) meta-xylylene diamine, 20.9 kg (103.5 moles) of sebacic acid and 500 g H₂O. The mixture thus formed is placed under an inert atmosphere and is heated until the temperature reaches 240° C. while keeping a maximum pressure of 30 bars. After maintaining these conditions for 1 hour, the pressure is slowly released for 2 hours until it reaches the atmospheric pressure. With the reactor under nitrogen flow, the polycondensation is continued at 275° C. for approximately 2 hours until the desired viscosity of the polymer is achieved. The final product has an intrinsic viscosity of 1.18 dl/g.

TABLE 1
Thermomechanic properties of MXD.10 and MXD.6

| | | | | | Flexural Modulus | | | |
|---|---|---|---|---|---|---|---|---|
| | | Tm: Melting | Processing | | by DMA (in | | Elongation at | Tensile Strength |
| | Tg (by DSC) | Temperature | Temperature | ΔH | traction) | Tensile Strength | Break | at Break |
| MXD.10 | 60° C. | 190° C. | 210° C. | 45 J/g | 1800 MPa | 91 MPa | 200% | 48 MPa |
| according | | | | | (>1500) | | | |
| to the | | | | | | | | |
| invention | | | | | | | | |
| MXD.6 | 90° C. | 241° C. | 250-270° C. | 52 J/g | 2400 MPa | 95 MPa | 5% | 60 MPa |
| (Example | | | | | (>2000) | | | |
| from | | | | | | | | |
| reference) | | | | | | | | |

The intrinsic viscosities, measured in meta-cresol, were carried out using method ISO 307(1994) at 20° C. The glass transition temperatures, melt temperatures and enthalpies of fusion were measured by DSC according to method ISO 111357-3 (1999).

The tensile and flexural thermo-mechanic properties were carried out on the injected bars using method ISO 527 (½) at 25 mm/min. The samples were previously conditioned at Tg+50° C.

The processing temperatures were observed during the extrusion of the products into films on a Randcastel extruder and confirmed by the conditions of the DSM injection molding.

### Example 2

### Film Extrusion of MXD10 Using the Blown Film Technology

The composition obtained in example 1 is extruded through an annular die with a 30 mm single screw extruder. The polymer is extruded at an output of 7.9 kg/h through a 50 mm diameter annular die. The bubble is drawn down in the molten stage at a speed of 9.8 m/min and the blow up ratio (defined as the ratio of the frozen bubble diameter compared to the die diameter) is equal to 2.5. The die gap is equal to 0.8 mm and the cooling device is a simple flux air ring, blowing air at 20° C. and leading to a freezing line height of 150 mm. These drawing conditions lead to a 30 μm MXD 10 film with a width of 393 mm. The film is referenced example 2.1. The properties of the film are described in table 2.

TABLE 2

| | |
|---|---|
| Machine Direction | Transverse Direction |

Mechanical Properties of the blown film of MXD.10 (Example 2.1)

| | | |
|---|---|---|
| Tensile Modulus (MPa) | 1377 | 1323 |
| Yield Deformation (%) | 2.9 | 2.8 |
| Yield Stress (MPa) | 24.8 | 24.7 |
| Deformation at break (%) | 241 | 293 |
| Stress at break (MPa) | 50.8 | 56.8 |

Optical Properties of Example 2.1

| | |
|---|---|
| Haze | 1.96 |

Permeation Properties of Example 2.1

| | |
|---|---|
| Oxygen Permeability at 0% | 56 |
| of Relative Humidity | |
| (cc · 25 μm/m² 24 h) | |
| Oxygen Permeability at | 47 |
| 50% of Relative Humidity | |
| (cc · 25 μm/m² 24 h) | |
| Oxygen Permeability at | 36 |
| 90% of Relative Humidity | |
| (cc · 25 μm/m² 24 h) | |

Tensile Modulus and Traction Properties are determined using ASTM D 882 method at 23° C. The samples were previously conditioned at 23° C. and 50% of relative humidity until the moisture content is stabilized.

Haze property is determined using ASTM D 1003 method

Permeation property is determined using ASTM D 3985 method on OTRAN apparatus at 23° C.

In order to compare the intrinsic properties of MXD10 film (example 2.1) with the properties of a polyamide 6, a film of polyamide 6 is made on the same apparatus used for the fabrication of example 2.1. Ultramid B35 from the BASF company is extruded at an output of 9.9 kg/h through a 50 mm diameter annular die. The bubble is drawn down in the molten stage at a speed of 10.1 m/min and the blow up ratio (defined as the ratio of the frozen bubble diameter compared to the die diameter) is equal to 2.5. The die gap is equal to 0.8 mm and the cooling device is a simple flux air ring, blowing air at 20° C. and leading to a freezing line height of 150 mm. These drawing conditions lead to a 30 μm Ultramid B35 film with a width of approximately 400 mm, The properties of this film are described in the table 3. The film of PA 6 is referenced as example 2.2.

Table 3 compares the intrinsic properties of MXD10 films, Ultramid B35 films (PA6) and MXD6 films and exhibits the unique balance of properties for MXD 10 with very high deformation at break, soft tensile modulus very good clarity and very good oxygen permeability at high level of relative humidity.

TABLE 3

| | | Example 2.2 | |
|---|---|---|---|
| | Example 2.1 | (Polyamide | |
| | (MXD10) | 6) | MXD6 |
| Tensile Modulus (Mpa) MD/TD | 1377/1323 | 754/767 | 3125/3103 |
| Deformation at break (%) | 241/293 | 323/315 | 3/2 |
| MD/TD | | | |
| Haze | 1.96 | 10.51 | 2.11 |
| Oxygen Permeability at 50% of | 47 | 36 | 3 |
| Relative Humidity | | | |
| (cc · 25 μm/m² 24 h) | | | |
| Oxygen Permeability at 70% of | 35 | 54 | 9 |
| Relative Humidity | | | |
| (cc · 25 μm/m² 24 h) | | | |
| Oxygen Permeability at 90% of | 36 | 125 | 6 |
| Relative Humidity | | | |
| (cc · 25 μm/m² 24 h) | | | |

Tensile Modulus and Traction Properties are determined using ASTM D 882 method at 23° C. The samples were previously conditioned at 23° C. and 50% of relative humidity until the moisture content is stabilized.

Haze property is determined using ASTM D 1003 method

Permeation property are determined using ASTM D 3985 method on OTRAN apparatus at 23° C.

### Example 3

### Film Extrusion of MXD10 Using the Cast Film Technology

The composition obtained in example 1 is extruded through a flat die with a 30 mm single screw extruder. The extruder is running at 80 rpm and is connected to a 250 mm flat die. The MXD10 is drawn down at the molten stage at a speed of 19.9 m/min and the draw ratio (defined as the ratio of the line speed compared to the extrusion speed) is equal to 11.2. The die gap is equal to 0.3 mm and the chill roll temperature setting is equal to 60° C. These drawing conditions lead to a 25 μm MXD 10 film. The properties of this film are described in the table 4 and show a similar balance of properties when using the cast film technology.

TABLE 4

| | |
|---|---|
| Machine Direction | Transverse Direction |

Mechanical Properties

| | | |
|---|---|---|
| Tensile Modulus (MPa) | 1233 | 1129 |
| Deformation at break (%) | 334 | 329 |

Permeation Properties

| | |
|---|---|
| Oxygen Permeability at | 40 |
| 50% of Relative Humidity | |
| (cc · 25 μm/m² 24 h) | |
| Oxygen Permeability at | 50 |
| 90% of Relative Humidity | |
| (cc · 25 μm/m² 24 h) | |

Tensile Modulus and Traction Properties are determined using ASTM D 882 method at 23° C. The samples were previously conditioned at 23° C. and 50% of relative humidity until the moisture content is stabilized.

Haze property is determined using ASTM D 1003 method.

Permeation property are determined using ASTM D 3985 method on OTRAN apparatus at 23° C.

### Example 4

### Film Coextrusion of MXD10 and EVOH Using the Blown Film Technology

The composition obtained in example 1 is coextruded with Soarnol 3803 ET (EVOH with 38% vinyl content) through an annular die. Each layer is extruded using the following extruders as defined in Table 5.

TABLE 5
Description of the extruders used to make the coextrusion

| | Screw Diameter | | Outpt |
|---|---|---|---|
| | (mm) | L/D | (kg/h) |
| MXD10 - Layer 1 | 25 | 30 | 2.5 |
| EVOH - Middle | 30 | 30 | 2.9 |
| Layer | | | |
| MXD10 - Layer 2 | 30 | 30 | 2.5 |

The polymers are extruded through a 50 mm diameter annular die using the “pancake” technology. The bubble is drawn down in the molten stage at a speed of 10.1 m/min and the blow up ratio (defined as the ratio of the frozen bubble diameter compared to the die diameter) is equal to 2.5. The die gap is equal to 0.8 mm and the cooling device is a simple flux air ring, blowing air at 20° C. and leading to a freezing line height of 150 mm. These drawing conditions lead to a three-layer film with the following structure [MXD10 (10 μm)/EVOH (10 μm)/MXD (10 μm)] with an approximate width of 400 mm. The film exhibits very good processability, including coextrudability and bubble stability. The properties of this film are described in table 6. The coextruded film is referenced as example 4.1. The properties of this film are compared with a three-layer film coextruded on the same equipment and using a regular Polyamide 6 (Ultramid B 35 from the company BASF) in replacement of MXD 10. The comparative structure is as follow [Ultramid B35 (10 μm)/Soarnol 3803 ET (10 μm)/Ultramid B35 (10 μm)] and its properties are referenced as example 4.2

TABLE 6

| | Example 4.1 | Example 4.2 |
|---|---|---|
| | (cc/m² · 24 h) | (cc/m² · 24 h) |
| Oxygen Permeability at 50% of | 1 | 1 |
| Relative Humidity | | |
| Oxygen Permeability at 70% of | 3 | 3.5 |
| Relative Humidity | | |
| Oxygen Permeability at 90% of | 22 | 29 |
| Relative Humidity | | |

Permeation property are determined using ASTM D 3985 method on OTRAN apparatus at 23° C. The samples were previously conditioned at 23° C. and 50% of relative humidity until the moisture content is stabilized.

1. Structure containing at least one layer made of a polyamide MXD.10/Z in which:
a) MXD.10 is the product of the condensation of a mixture of xylylenediamines having 70 to 100% of meta-xylylenediamine and of sebacic acid,
by) Z is a repeating unit selected from the group consisting of
1) repeating units resulting from the polycondensation of a lactam monomer,
2) an alpha-omega carboxylic aminoacid,
3) the repeating unit X1.Y1 where X1 designates the repeating unit resulting from the polycondensation an aliphatic, arylaliphatic, cycloapiphatic, or aromatic diamine and Y1 designates the repeating unit resulting from the polycondensation of a aliphatic carboxylic, cycloaliphatic or aromatic diacid,
the weight ratio Z/(MXD+10+Z) is between 0 and 15%.

2. Structure according to claim 1 in which the proportion of Z in the polyamide MXD.10/Z is between 0 and 10%.

3. Structure according to claim 2 in which this proportion is between 0 and 5%.

4. Structure according to claim 1 in which the lactam in Z 1) is chosen among caprolactam and the lauryllactam.

5. Structure according to claim 1 in which in Z the number of carbon atoms of X1 is between 6 and 22.

6. Structure according to claim 1 in which in Z the number of carbon atoms of Y1 is between 6 and 14.

7. Structure according to claim 1, wherein said structure comprises bottles, tanks, containers, tubes and any types of containment devices.

8. Structure according to claim 1, wherein said structure comprises a film.

9. Blends of MXD.10/Z with at least one product chosen from other polymers, fillers such as fibers or nanocomposites.

10. Structure of claim 8, wherein said structure comprises packaging.
